(19) United States
(12) Patent Application Publication
(10) Pub. No.: US 2020/0150081 A1
(43) Pub. Date: May 14, 2020

(54) METHOD FOR DETERMINING THE TEMPERATURE OF A SOLID ELECTROLYTE GAS SENSOR

(71) Applicant: Robert Bosch GmbH, Stuttgart (DE)

(72) Inventors: Bernhard Ledermann, Weil Der Stadt (DE); Fabian Baumann, Affalterbach (DE)

(21) Appl. No.: 16/609,634

(22) PCT Filed: Mar. 23, 2018
(86) PCT No.: PCT/EP2018/057459

§ 371 Date: Oct. 30, 2019

(30) Foreign Application Priority Data
May 9, 2017 (DE) 10 2017 207 802.2

(51) Int. Cl. G01N 27/416; G01N 27/406

(52) U.S. Cl. CPC G01N 27/4163; G01N 27/4067

(57) ABSTRACT

A method for determining a temperature of a sensor for detecting at least one property of a measured gas in a measured-gas space. The sensor includes a sensor-element (SeE) for detecting the property of the measured gas. The SeE includes a first-electrode (FE), a second-electrode (SE), and a solid-electrolyte connecting the FE and SE. The sensor includes an electronic-control-unit. The method includes: establishing an operating-state, a heating-voltage being applied to the SeE and a substantially constant-voltage-state being established at the SeE and detected; a) carrying out a diagnosis-sequence, a first-diagnosis-state (DS) being established by impinging upon the SeE with a diagnosis-current, a second-DS being established in which the diagnosis-current is switched off, in the first-DS a first-voltage-value being detected, and in the second-DS a second-voltage-value being detected; b) determining an information-item regarding the temperature from the first-voltage-value and second-voltage-value, and from the constant-voltage-state of the operating-state.

### FIELD OF THE INVENTION

The present invention relates to a method for determining the temperature of a solid electrolyte gas sensor.

### BACKGROUND INFORMATION

The related art is believed to refer to a plurality of sensors and methods for detecting at least one property of a measured gas in a measured-gas space. The properties of the measured gas can be, in principle, any physical and/or chemical properties of the measured gas, and one or several properties can be detected. The invention will be described hereinafter in particular with reference to a qualitative and/or quantitative detection of a concentration of a gas component of the measured gas, in particular with reference to detection of an oxygen concentration in the measured-gas part. The oxygen concentration can be detected, for example, in the form of a partial pressure and/or in the form of a percentage. Other properties of the measured gas are, however, also alternatively or additionally detectable.

The related art are believed to refer to ceramic sensors that encompass a sensor element based on the use of electrolytic properties of specific solids, i.e. ion-conducting properties of those solids. Those solids can be, in particular, ceramic solid electrolytes, for example zirconium dioxide (ZrO₂), in particular yttrium-stabilized zirconium dioxide (YSZ) and scandium-doped zirconium dioxide (ScSZ), which can contain small additions of aluminum oxide (Al₂O₃) and/or silicon oxide (SiO₂). Such sensors can be configured, for example, as so-called lambda probes or as nitrogen oxide sensors, as known e.g. from K. Reif, Deitsche, K.-H., et al., Kraftfahrzeugtechnisches Taschenbuch [Automotive Handbook], Springer Vieweg, Wiesbaden, 2014, pp. 1338-1347. Using broadband lambda probes, for example, in particular planar broadband lambda probes, the oxygen concentration in an exhaust gas, for example, can be determined over a wide range, and conclusions can thus be drawn as to the air/fuel ratio in the combustion chamber. The excess-air factor λ (lambda) describes this air/fuel ratio. Nitrogen oxide sensors determine the concentration both of nitrogen oxides and of oxygen in the exhaust gas.

By combining a pump cell, the measurement cell, and an oxygen reference cell (Nernst cell), it is possible to construct a sensor for measuring the oxygen content in an ambient gas. In a pump cell that operates on the amperometric pumping principle, upon application of a voltage or a current to the pump electrodes that are located in different gas spaces, an oxygen ion current diffuses through a ceramic body (the oxygen-conducting solid electrolyte) that separates the gas spaces (“pumping”). If the pump cell is used to maintain a constant oxygen partial pressure in a cavity into which the ambient gas can diffuse, it is then possible, by measuring the electrical current, to infer the quantity of oxygen transported. In accordance with the diffusion law, this pump current is directly proportional to the oxygen partial pressure in the ambient gas. Using a Nernst cell, the ratio between the oxygen partial pressure in the cavity and the oxygen partial pressure in a further reference-gas space can be determined by way of the Nernst voltage that occurs.

Broadband lambda probes require, for various functionalities, information regarding a temperature of the ceramic of the sensor element. In the vicinity of the operating point of the sensor, for example 780° C., the information regarding the temperature of the ceramic can be ascertained by way of a temperature-dependent property of the ceramic, in particular the internal resistance of the Nernst cell. A sensor can have at the Nernst cell a resistance, specified by the manufacturers, of 300 ohms.

Also, there are control units that are configured to ascertain the internal resistance for determining the temperature of the sensor. Such control units encompass, however, differential and mass-related capacitances in order to stabilize various sensor signals, so that distortion of the actual ohmic measurement can occur. In a measurement arrangement having a current source for measuring the ohmic resistance, a settling time until an ohmic target value is reached can be proportional to that time and to the differential capacitances. This can result in severe distortion of the resistance measurements of large resistance values.

In broadband lambda probes, extended energization times can result in a high level of polarization of the pumping electrode. This high level of polarization can result in a further distortion of the resistance measurement. This polarization, as well as the ohmic voltage swing at the Nernst cell when control is applied by a current source, can be proportional (to a first approximation) to resistance and current amplitude, so that a probability of irreversible processes in the ceramic is increased, and the sensor element can become permanently damaged. With old or damaged sensors, a decrease in the sensor electrode capacitance can be possible, which in turn can result in polarization of the electrode and additional distortion of the resistance measurement.

### SUMMARY OF THE INVENTION

A method is therefore provided for determining a temperature of a sensor for detecting at least one property of a measured gas in a measured-gas space, which method at least largely avoids the disadvantages of known methods for operating such sensors, and in which method, in particular, an influence on an ohmic measurement of differential capacitances incorporated into a control unit, and of polarization of the sensor electrode, can be reduced.

A method according to the present invention for operating a sensor for detecting at least one property of a measured gas in a measured-gas space, in particular for detecting a concentration of a gas component in the measured gas, is proposed. The sensor has at least one sensor element for detecting the property of the measured gas. The sensor element encompasses at least one first electrode, at least one second electrode, and at least one solid electrolyte connecting the first electrode and the second electrode. The measurement system has at least one electronic control unit. The method has the following steps:
a) establishing an operating state, a heating voltage being applied to the sensor element and a substantially constant voltage state being established at the sensor element and detected;
b) carrying out at least one diagnosis sequence, at least one first diagnosis state being established by impinging upon the sensor element with a diagnosis current, at least one second diagnosis state being established in which the diagnosis current is switched off, in the first diagnosis state at least one first voltage value being detected, and in the second diagnosis state at least one second voltage value being detected;
c) determining an information item regarding the temperature from the first voltage value and the second voltage value, and from the constant voltage state of the operating state.

The method steps can be carried out in the sequence indicated. A different sequence is also possible in principle. In addition, one or several or all method steps can also be carried out repeatedly. In addition, two or more of the method steps can also be carried out entirely or partly overlappingly in time or simultaneously. The method can also encompass further method steps in addition to the method steps recited.

A “sensor” can be understood in principle as any apparatus that is configured to detect a concentration of a gas component, in particular in a gas mixture, for example in a measured-gas space such as an exhaust gas section of an internal combustion engine. The sensor can be, for example, a broadband lambda sensor or a NOx sensor.

A “sensor element for detecting at least one concentration of a gas component in a gas” can be understood as an element that, for example as a constituent of the sensor apparatus, is configured to detect, or can contribute to the detection of, a concentration of a gas component of a gas. Reference may be made in principle to the aforementioned existing art regarding possible embodiments of the sensor element. The sensor element can be, in particular, a ceramic sensor element, in particular a ceramic sensor element having a layered construction. The sensor can be, in particular, a planar ceramic sensor element. A “detection of at least one concentration of a gas component” can be understood as a qualitative and/or quantitative detection of a gas component of the gas. In principle, however, the sensor element can be configured to detect any physical and/or chemical property of the gas, for example a temperature and/or a pressure of the gas and/or particles in the gas. Other properties are also, in principle, detectable. The gas can be, in principle, any gas, for example exhaust gas, air, an air/fuel mixture, or also a different gas. The invention is usable in particular in the field of automotive engineering, so that the gas in particular can be an air/fuel mixture. In general, a “measured-gas space” can be understood as a space in which the gas to be detected is located. The invention can be usable in particular in the field of automotive engineering, so that the measured-gas space can be, in particular, an exhaust section of an internal combustion engine. Other applications are, however, conceivable.

An “electrode” is to be understood in general in the context of the present invention as an element that is capable of contacting the solid electrolyte in such a way that a current can be maintained through the solid electrolyte and the electrode. The electrode can accordingly encompass an element at which ions can be introduced into and/or extracted from the solid electrolyte. The electrodes typically encompass a noble-metal electrode that can be applied onto the solid electrode, for example, as a metal-ceramic electrode or can be connected to the solid electrolyte in another manner. Typical electrode materials are platinum-cermet electrodes. Other noble metals, however, for example gold or palladium, are usable in principle. The designations “first” and “second” as well as “third” and “fourth” electrode are used merely as designations and, in particular, provide no information as to a sequence and/or as to whether, in particular, further electrodes are also present.

The first electrode can be impingeable upon with gas from the measured-gas space. In particular, the first electrode can be connected at least in part to the measured-gas space; for example, the first electrode can be directly exposed to the gas of the measured-gas space and/or can be impingeable upon with gas from the measured-gas space through a gas-permeable porous protective layer. The sensor element can have at least one pump cell. The first electrode can be configured, for example, as an external pump electrode.

The second electrode can be disposed in at least one measurement cavity. The second electrode can be configured, for example, as an internal pump electrode. A “measurement cavity” can be understood as a cavity, within the sensor element, which can be configured to receive a reservoir of a gas component of the gas. The measurement cavity can be configured to be entirely or partly open. The measurement cavity can furthermore be entirely or partly filled, for example with a porous medium, for example with porous aluminum oxide.

The measurement cavity can be impingeable upon, via at least one diffusion barrier, with gas from the measured-gas space. A “diffusion barrier” can be understood as a layer made of a material that promotes diffusion of a gas and/or fluid and/or ions, but suppresses a flow of the gas and/or fluid. The diffusion barrier can have, in particular, a porous ceramic structure with specifically established pore radii. The diffusion barrier can have a diffusion resistance, the “diffusion resistance” being understood as the resistance presented by the diffusion barrier to diffusion transport.

The first electrode and the second electrode are connected via at least one solid electrolyte and form a pump cell. As a result of application of a voltage, in particular a pump voltage, to the first and the second electrode, oxygen can be pumped, through the diffusion barrier, into or out of the gas in the measurement cavity.

A “solid electrolyte” is to be understood in the context of the present invention as a body or object having electrolytic properties, i.e. having ion-conducting properties. It can be, in particular, a ceramic solid electrolyte. This also encompasses the raw material of a solid electrolyte, and thus the embodiment as a so-called “green compact” or “brown compact” that becomes a solid electrolyte only after sintering. The solid electrolyte can be embodied in particular as a solid electrolyte layer or from several solid electrolyte layers. A “layer” is to be understood in the context of the present invention as a uniform mass having a planar extent of a certain height, which is located over, under, or between other elements. A solid electrolyte can be, in particular, a ceramic solid electrolyte, for example zirconium dioxide, in particular yttrium-stabilized zirconium dioxide (YSZ) and/or scandium-doped zirconium dioxide (ScSZ). The solid electrolyte can be gas-impermeable and/or can ensure ionic transport, for example ionic oxygen transport. In particular, the first and the second electrode can be an electrically conductive region, for example an electrically conductive metallic coating, which can be applied onto the at least one solid electrolyte and/or can contact the solid electrolyte in another manner. In particular, by application of a voltage, in particular a pump voltage, to the first and the second electrode, oxygen can be pumped into or out of the gas in the measurement cavity.

The sensor element can have further electrodes, for example a third and a fourth electrode. The sensor element can have at least one Nernst cell, which has the at least third electrode and the at least fourth electrode that are connected to the solid electrolyte. Embodiments in which the third electrode is configured as a pump electrode, and the sensor does not have a fourth electrode, are conceivable.

The third electrode can be configured as a reference electrode embodied separately from the measured-gas space. The third electrode can be connected at least in part, for example fluidically and/or via a gas connection, to a reference-gas space. A “reference-gas space” can be understood as a space, inside the sensor element, which is connected to an ambient space, for example an ambient space around an internal combustion engine. Air, in particular, can be in the ambient space. The reference-gas space can in particular be connected to the measurement cavity via the solid electrolyte. The fourth electrode can be configured as a Nernst cell that can be disposed in the measurement cavity.

An “electronic control unit” can be understood in general as an electronic apparatus that is configured to operate and control the sensor. For example, one or several electronic connections can be provided between the sensor and the electronic control unit. The electronic control unit can encompass, for example, at least one data processing apparatus, for example at least one computer or microcontroller. The electronic control unit can have at least one integrated circuit, in particular an application-specific integrated circuit (ASIC). The data processing apparatus can have one or several volatile or nonvolatile data memories; the data processing apparatus can be configured in terms of program technology, for example, to apply control to the sensor. The electronic control unit can furthermore encompass at least one interface, for example an electronic interface and/or a human/machine interface, for example an input/output apparatus such as a display and/or a keyboard. The electronic control unit can be constructed, for example, in centralized or a decentralized manner. Other configurations are also conceivable.

The sensor element can have a heating element. A “heating element” is to be understood in the context of the present invention as an element that serves to heat the solid electrolyte and the electrodes at least to their functioning temperature and which may be to their operating temperature. The functioning temperature is the temperature above which the solid electrolyte becomes conductive to ions, and is equal to approximately 350°. It is to be distinguished from the operating temperature, which is the temperature at which the sensor element is usually operated, and which is higher than the functioning temperature. The operating temperature can be, for example, 700° C. to 950° C. The heating element can encompass a heating region and at least one supply lead conductor. A “heating region” is to be understood in the context of the present invention as that region of the heating element which, in the layer structure, overlaps with an electrode in a direction perpendicular to the surface of the sensor element. The heating region usually heats during operation up more than the supply lead conductor, so that they are distinguishable. The difference in heating can be implemented, for example, by the fact that the heating region has a higher electrical resistance than the supply lead conductor. The heating region and/or the supply lead are embodied, for example, as electrical resistance conductors, and heat up due to application of an electrical voltage. The heating element can be produced, for example, from platinum-cermet. An “operating state” can be understood as a state of the sensor in which the operating temperature has been reached and, after changes in current or voltage, an electrically stable state is reached at the sensor element. In the operating state, a substantially constant voltage state becomes established at the Nernst cell. In a heating-up phase of the sensor, a voltage between the electrodes of the sensor element can exhibit a settling behavior. A “substantially constant voltage state” can be understood to mean that the voltage between the electrodes reaches a steady-state value, deviations of less than 10%, which may be less than 5%, particularly may be less than 1%, from a steady-state value being possible. In the operating state, a constant current can be present at the sensor element; an offset voltage not equal to zero can also be present between the electrodes of the sensor element.

A “diagnosis sequence” can be understood as a sequence of diagnosis states. A “diagnosis state” can be understood as a switching state. In the first diagnosis state, the sensor element is impinged upon with a diagnosis current. An “impingement upon the sensor element with a diagnosis current” can be understood to mean that predefined or predefinable current is applied via the electrodes to the sensor element, in particular by way of a current source. The current source can be a constituent of the control unit, or can be configured separately from the control unit. The sensor can exhibit a settling behavior when impinged upon with the diagnosis current, in particular an exponential settling behavior. An exponential settling process in the first diagnosis state to a target value upon energization with the current I can satisfy the condition

U(t)=U(t₀)+(U_{offset}+Rᵢₙₜ·I−U(t₀))(1−exp(−(t−t₀)/τ)),

where U_{offset} is the offset voltage value between the electrodes in the operating state, Rᵢₙₜ is the internal resistance between the electrodes in the operating state, t₀ is a point in time at which the current source is switched on, τ is a time constant of a charging time of an effective differential total capacitance C_{diff} of the control unit. In particular, τ=Rᵢₙₜ·C_{diff}.

In the second diagnosis state, the diagnosis current is switched off. In particular, the sensor element is unenergized with respect to the diagnosis current. In particular, the current source can be shut off in the second diagnosis state. The sensor element can exhibit, upon shutoff, an electrical decay behavior, in particular an exponential decay behavior. An exponential decay process in the second diagnosis state, with a time constant identical to the one in the settling process, can satisfy the condition

U(t)=U(t₀)+(U_{offset}−U(t₀))(1−exp(−(t−t₀)/τ)),

where t₀ in this case is a point in time at which the current source is shut off.

In the method, a plurality of diagnosis sequences can be carried out. In particular, the first diagnosis state and the second diagnosis state can be repeatedly established successively and alternately, for example periodically. The plurality can encompass two, three, four, or more diagnosis sequences. A number of repetitions, referred to hereinafter also as “iterations,” can depend on a desired or predefined accuracy of the determination of the internal resistance. A duration of the first diagnosis state and a duration of the second diagnosis state can be of identical length. Alternatively, the duration of the first diagnosis state and the duration of the second diagnosis state can be different.

In the first diagnosis state the at least one first voltage value is detected, and in the second diagnosis state the at least one second voltage value is detected. A “detection of a voltage value” can be understood as a measurement and/or determination of the voltage value between the electrodes of the sensor element. The first measured voltage value can be determined during the settling process. The second measured voltage value can be determined during the decay process. Detection of the first measured voltage value can occur in each of the diagnosis sequences at an identical point in time within the settling process. Detection of the second measured voltage value can occur in each of the diagnosis sequences at an identical point in time within the decay process.

An “information item regarding the temperature” can be understood as a determination of a internal resistance of the sensor element. The internal resistance can be an indicator of the temperature of the sensor element. In particular, the temperature of the sensor element can be determined from the internal resistance by way of a predefined or predeterminable correlation. In method step c), the internal resistance Rᵢₙₜ of the sensor element can be determined from the relationship:

Rᵢₙₜ[i]=(abs(U[i]+U[i−1])+2·ΔUₘₑₐₛ[i])/I,

where I is the diagnosis current at the sensor element. After a few repeated measurements, a settling error ΔUₘₑₐₛ[i] can be of equal magnitude during the charging and the discharging process. In the decay process, the settling error can be determined in comparison with the offset voltage value and can be taken into account in determining the internal resistance. In method step c), the internal resistance Rᵢₙₜ of the sensor element can be determined from the relationship:

Rᵢₙₜ[i]=(U[i]+U[i−1]−2U_{offset})/I,

where I is the applied diagnosis current, i is an iteration step, U[i] is a measured voltage value of the i-th iteration step, U[i−1] is a measured voltage value of the (i−1)-th iteration step, and U_{offset} is the offset voltage value in the operating state.

In the method, a capacitance difference, in particular the effective differential total capacitance C_{diff} of at least one differential capacitance of the electronic control unit, can be determined from the relationship

$${C}_{diff} [ i ] = τ [ i ] / {R}_{int} [ i ] , \\ where$$

$$τ ( i ) = - \frac{{t}_{meas}}{log ( 1 - \frac{( U [ i ] - {U}_{offset} )}{{R}_{int} [ i ]} \cdot I )}$$

where τ is a time constant of the charging time of the effective differential total capacitance, i is an iteration step, U[i] is a measured voltage value of the i-th iteration step, U_{offset} is the offset voltage value, tₘₑₐₛ is a point in time of the measurement after energization is switched on or shut off, and Rᵢₙₜ is the internal resistance. The differential total capacitance that is determined can be used to further configure the energization in terms of time, and/or for further diagnostic purposes.

The method can encompass an output step in which the information regarding the temperature and/or regarding the value of the differentially effective capacitances is outputted. Alternatively or additionally, the result can be stored in the control unit.

Once the substantially constant voltage state is reached, it is then possible by way of the above-described relationship, despite a voltage measurement in a non-stabilized state, to determine by way of alternating application of energized and unenergized diagnosis states of equal length, and fixedly defined measurements, in each phase, an internal resistance in which systematic errors due to the additional differential capacitances cancel one another out. In particular, the influence of the differential capacitances on the determination of the internal resistance can already be reduced by determining the offset voltage value in the operating state and then carrying out the diagnosis sequence one time.

In a further aspect, a computer program is proposed which is configured to carry out each step of the method according to the present invention. Also proposed is an electronic storage medium on which a computer program for carrying out the method according to the present invention is stored. In a further aspect, an electronic control unit, which encompasses the electronic storage medium according to the present invention having the aforesaid computer program for carrying out the method according to the present invention, is proposed. With regard to definitions and embodiments, reference is made to the description of the method according to the present invention.

In a further aspect, a sensor is proposed for detecting at least one property of a measured gas in a measured-gas space, in particular for detecting a concentration of a gas component in a measured gas. The sensor has a sensor element for detecting the property of the measured gas. The sensor element has at least one element. The sensor encompasses at least one first electrode, at least one second electrode, and at least one solid electrolyte connecting the first electrode and the second electrode. The sensor element can have at least one pump cell. The sensor element can furthermore have at least one Nernst cell. The Nernst cell can encompass at least one third electrode and at least one fourth electrode that are connected to the solid electrolyte. The sensor furthermore has an electronic control unit having the computer program according to the present invention for carrying out the method according to the present invention. With regard to definitions and embodiments, reference is made to the description of the method according to the present invention.

The proposed methods and apparatuses are advantageous with respect to known methods and apparatuses. The method can reduce the influence of the differential or differentially effective capacitances incorporated into the control unit, and the influence of polarization of the probe electrodes, on an ohmic measurement, in particular accompanied by a decrease in an average voltage load. Perturbation terms, in particular the differential or differentially effective capacitances incorporated into the control unit, can be partly eliminated by alternating polarization and depolarization, and the voltage load at the measurement cell can be decreased, specifically at high target resistance values, almost by half as compared with known methods. The method can make possible a more robust resistance measurement. The method can decrease aging effects and reduce their negative repercussions by way of the more robust resistance measurement.

The method can be used in principle for any control units that determine an ohmic resistance by way of a current source, the measurement of which is, however, distorted by capacitance differences and/or polarization effects.

Further optional details and features of the invention are evident from the description below of exemplary embodiments that are schematically depicted in the Figures.

### BRIEF DESCRIPTION OF THE DRAWINGS

FIG. 1 shows an exemplifying embodiment of a sensor according to the present invention.

FIGS. 2A to D are circuit diagrams of a sensor according to the present invention.

FIG. 3 shows a time course of the voltage between electrodes of a sensor element, and a time course of a diagnosis current.

FIG. 4 shows a relative internal resistance as a function of an iteration step.

FIG. 5 shows a comparison of a time course until knowledge of a settling time of a continuously energized sensor element, and an energization according to the present invention.

FIG. 6 shows a relative differential capacitance as a function of the iteration step.

### DETAILED DESCRIPTION

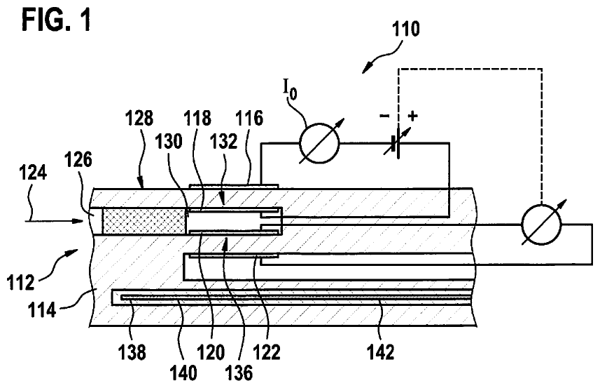

FIG. 1 shows the general construction of a sensor 110 according to the present invention. Sensor 110 depicted in FIG. 1 can be used to detect physical and/or chemical properties of a measured gas in a measured-gas space, in which context one or several properties can be detected. The invention will be described below with reference in particular to a qualitative and/or quantitative detection of a gas component of the measured gas, in particular with reference to a detection of an oxygen concentration in the measured gas. The oxygen concentration can be detected, for example, in the form of a partial pressure and/or in the form of a percentage. Other types of gas components are, however, also detectable in principle, for example nitrogen oxides, hydrocarbons, and/or hydrogen. Alternatively or additionally, however, other properties of the measured gas are also detectable. The invention is usable in particular in the field of automotive engineering, so that the measured-gas space can be, in particular, an exhaust section of an internal combustion engine and the measured gas can be, in particular, an exhaust gas.

Sensor 110 has a sensor element 112. Sensor element 112 can be embodied as a ceramic layer structure, as will be described in more detail below. Sensor element 112 has a solid electrolyte 114, a first electrode 116, and a second electrode 118. The sensor element can have a third electrode 120 and a fourth electrode 122. Solid electrolyte 114 can be assembled from several ceramic layers in the form of solid-electrolyte layers, or can encompass several solid-electrolyte layers. Solid electrolyte 114 encompasses, for example, a pump film or pump layer, an intermediate film or intermediate layer, and a heating film or heating layer, which are arranged above or below one another. Sensor element 110 can have a gas entrance path 124. Gas entrance path 124 can have a gas entrance hole 126 that extends from a surface 128 of solid electrolyte 114 into the interior of the layer structure of sensor element 114.

First electrode 116 can be disposed on surface 128 of solid electrolyte 114. First electrode 116 can be impingeable upon with gas from the measured-gas space. In particular, first electrode 116 can be connected at least in part to the measured-gas space; for example, the first electrode can be exposed directly to the gas of the measured-gas space and/or can be impingeable upon, through a gas-permeable porous protective layer, with gas from the measured-gas space. First electrode 116 can be configured, for example, as an external pump electrode.

Second electrode 118 can be disposed in at least one measurement cavity 130. Second electrode 118 can be configured, for example, as an internal pump electrode. Measurement cavity 130 can be configured to be entirely or partly open. Measurement cavity 130 can furthermore be entirely or partly filled, for example with a porous medium, for example with porous aluminum oxide. Measurement cavity 130 can be impingeable upon, via at least one diffusion barrier, with gas from the measured-gas space.

First electrode 116 and second electrode 118 are connected via the at least one solid electrolyte 114 and can form a pump cell 132. As a result of application of a voltage, in particular a pump voltage, to first electrode 116 and to second electrode 118, oxygen can be pumped through the diffusion barrier into or out of the gas in measurement cavity 130.

Third electrode 120 can be configured as a reference electrode embodied separately from the measured-gas space. Third electrode 120 can be connected at least in part, for example fluidically and/or via a gas connection, to a reference-gas space 134 (not shown here). Reference-gas space 134 can be connected, in particular via solid electrolyte 114, to measurement cavity 130. Fourth electrode 122 can be configured as a Nernst electrode that can be disposed in measurement cavity 130. Third electrode 120 and fourth electrode 122 can be connected via the at least one solid electrolyte 114 and can form a Nernst cell 136.

By way of pump cell 132, for example, a pump current can be established by pump cell 132 in such a way that the condition λ (lambda)=1, or another known composition, exists in measurement cavity 130. That composition is in turn detected by Nernst cell 136 by the fact that a Nernst voltage V_{N} between third electrode 120 and fourth electrode 122 is measured. Because a known gas composition exists in reference-gas space 134, or because it is exposed to an oxygen excess, the composition in measurement cavity 130 can be inferred on the basis of the measured voltage.

A heating element 138 can be disposed in the layer structure of sensor element 112 in the prolongation of the direction of extent of gas entrance hole 126. Heating element 138 has a heating region 140 and electrical supply lead conductors 142. Heating region 140 is embodied, for example, in a serpentine manner.

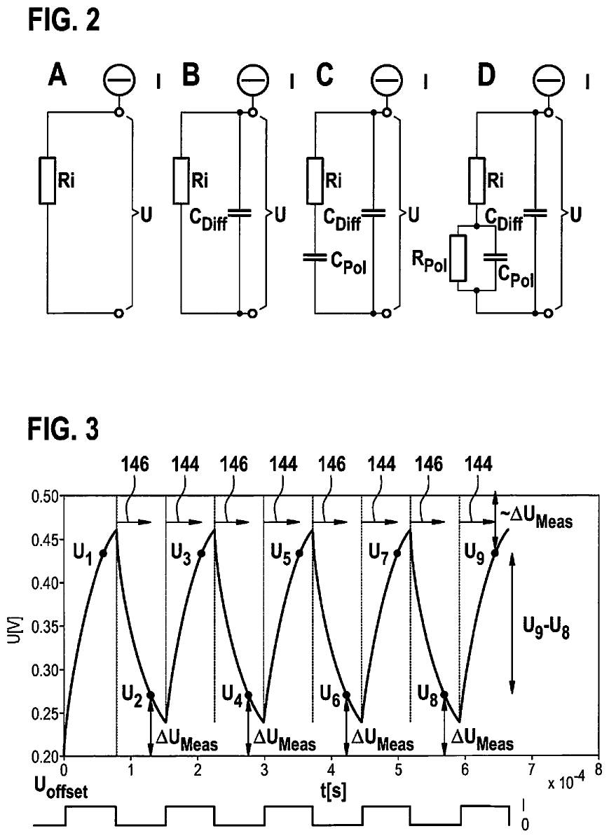

FIGS. 2A to 2D are circuit diagrams of sensor element 136 (in this case, the Nernst cell) according to the present invention. FIG. 2A shows an ideal circuit having no differential or differentially acting capacitances incorporated into the control unit. FIGS. 2B to 2C show further circuit components C_{diff} and Cₚₒₗ, for example in parallel with a polarization resistance Rₚₒₗ.

FIG. 3 shows a time course of an embodiment of the method according to the present invention. Once an operating state has been established, characterized by the voltage value U_{offset} in FIG. 3, at least one diagnosis sequence is executed in which at least one first diagnosis state 144 is established by impinging on sensor element 112, for example Nernst cell 136, with a diagnosis current, and establishing a second diagnosis state 146 in which the diagnosis current is shut off, so that the Nernst cell is unenergized with respect to the diagnosis current. The lower part of FIG. 3 shows a time course of the diagnosis current, showing in particular the diagnosis current being switched in and out. The diagnosis current can be switched in and out by switching a current source on or off. FIG. 3 furthermore shows a time course of the voltage between electrodes of Nernst cell 136. In this exemplifying embodiment, a first diagnosis state 144 is established five times, and a second diagnosis state 146 four times. In the method, a plurality of diagnosis sequences can be carried out. In particular, first diagnosis state 144 and second diagnosis state 146 can be repeatedly established successively and alternately, for example periodically. The plurality can encompass two, three, four, or more diagnosis sequences. A number of repetitions can depend on a desired or predefined accuracy of the determination of the internal resistance. A duration of first diagnosis state 144 and a duration of second diagnosis state 146 can be of identical length. Alternatively, the duration of first diagnosis state 144 and the duration of second diagnosis state 146 can be different.

Sensor 110 can exhibit a settling behavior upon impingement with the diagnosis current, in particular an exponential settling behavior. An exponential settling process in first diagnosis state 144 to a target value upon energization with the current I can satisfy the condition

U(t)=U(t₀)+(U_{offset}+Rᵢₙₜ·I−U(t₀))(1−exp(−(t−t₀)/τ)),

where U_{offset} is the offset voltage value between the Nernst electrodes in the operating state, Rᵢₙₜ is the internal resistance of the Nernst cell, t₀ is a point in time at which the current source is switched on, τ is a time constant of a charging time of an effective differential total capacitance C_{diff} of the control unit. In particular, τ=Rᵢₙₜ·C_{diff}.

In second diagnosis state 146, Nernst cell 136 is unenergized. In particular, the current source can be shut off in second diagnosis state 146. Sensor element 112 can exhibit, upon shutoff, an electrical decay behavior, in particular an exponential decay behavior. An exponential decay process in the second diagnosis state, with a time constant identical to the one in the settling process, can satisfy the condition

U(t)=U(t₀)+(U_{offset}−U(t₀))(1−exp(−(t−t₀)/τ)),

where t₀ in this case is a point in time at which the current source is shut off.

In first diagnosis state 144, at least one first voltage value is detected, and in second diagnosis state 146 at least one second voltage value is detected. The first measured voltage value can be determined during the settling process, indicated in FIG. 3, for example, as U₁, U₃, U₅, U₇, and U₉. The second measured voltage value can be determined during the decay process, indicated in FIG. 3, for example, as U₂, U₄, U₆, and U₈. Detection of the first measured voltage value can occur, in each of the diagnosis sequences, at an identical point in time within the settling process. Detection of the second measured voltage value can occur, in each of the diagnosis sequences, at an identical point in time within the decay process.

An information item regarding temperature is determined from the first voltage value and the second voltage value. The internal resistance can be an indicator of the temperature of sensor element 112. In particular, the temperature of sensor element 112 can be determined from the internal resistance by way of a predefined or predeterminable correlation. In method step c), the internal resistance Rᵢₙₜ of sensor element 112 can be determined from the relationship:

Rᵢₙₜ[i]=(abs(U[i]+U[i−1])+2·ΔUₘₑₐₛ[i])/I,

where I is the diagnosis current at the sensor element. After a few repeated measurements, a settling error ΔUₘₑₐₛ, indicated in FIG. 3 as ΔUₘₑₐₛ[i], can be of equal magnitude during the charging and the discharging process. In the decay process, the settling error can be determined in comparison with the offset voltage value and can be taken into account in determining the internal resistance. In method step c), the internal resistance Rᵢₙₜ of the Nernst cell can be determined from the relationship:

Rᵢₙₜ[i]=(U[i]+U[i−1]−2U_{offset})/I,

where I is the applied diagnosis current, i is an iteration step, U[i] is a measured voltage value of the i-th iteration step, U[i−1] is a measured voltage value of the (i−1)-th iteration step, and U_{offset} is the offset voltage value in the operating state.

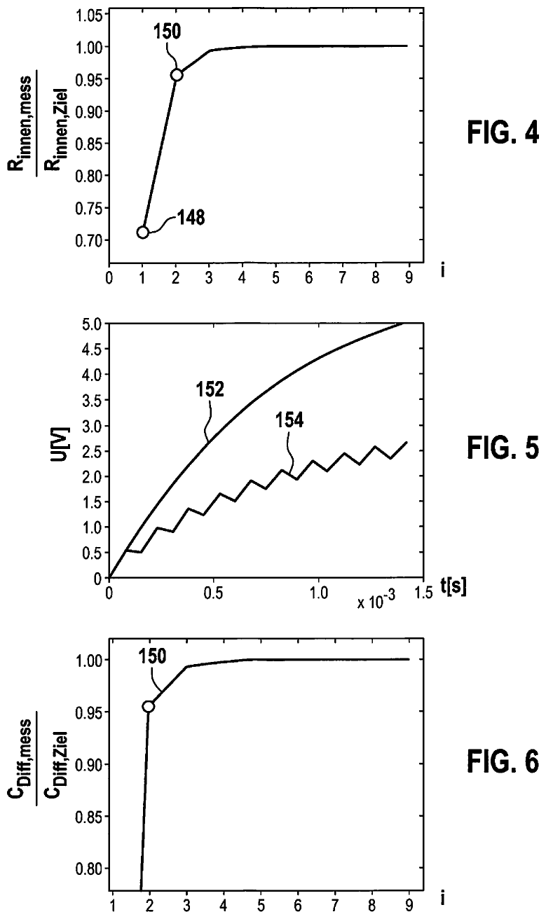

FIG. 4 shows a correlation between a relative internal resistance, i.e. the internal resistance R_{int,meas} determined by way of the method according to the present invention, divided by a target internal resistance R_{int,target}, in this case 1 KΩ, as a function of an iteration step i. An improvement in the determination of the internal resistance can be achieved depending on the number of alternately applied diagnosis steps. In FIG. 4, two measurement points are plotted for comparison. At a first measurement point 148, the internal resistance was determined with an unenergized and an energized measurement. At a second measurement point 150, firstly a completely stabilized unenergized measurement, then an energized measurement, and then a further unenergized measurement were carried out to determine the internal resistance. An improvement from 71% to 96% is achievable here, compared with determination using only one unenergized and one energized measurement. An even greater number of energization processes can be useful especially for considerable higher resistance values.

A time that is effectively required until knowledge of the settling time of the system can be equally long for a continuously energized system and for an alternately energized system. FIG. 5 shows a comparison of a time course until knowledge of a settling time of a continuously energized Nernst cell (curve 152) and energization according to the present invention (curve 154).

In the method, a capacitance difference, in particular the effective differential total capacitance C_{diff}, of at least one differential capacitance of the electronic control unit, can be determined from the relationship

$${C}_{diff} [ i ] = τ [ i ] / {R}_{int} [ i ] , \\ where$$

$$τ ( i ) = - \frac{{t}_{meas}}{log ( 1 - \frac{( U [ i ] - {U}_{offset} )}{{R}_{int} [ i ]} \cdot I )}$$

where τ is a time constant of the charging time of the effective differential total capacitance, i is an iteration step, U[i] is a measured voltage value of the i-th iteration step, U_{offset} is the offset voltage value, tₘₑₐₛ is a point in time of the measurement after energization is switched on or shut off, and Rᵢₙₜ is the internal resistance. The differential total capacitance that is determined can be used to further configure the energization in terms of time, and/or for further diagnostic purposes.

FIG. 6 shows a correlation between a relative differential capacitance, i.e. the effective differential capacitance C_{diff,meas} determined by way of the method according to the present invention, divided by a target capacitance C_{diff,target}, in this case 40 ns, as a function of an iteration step i. An improvement in the determination of the differential capacitance can be achieved depending on the number of sequences of energized and unenergized measurements. The capacitance difference can already be determined with 95% accuracy at the second measurement point 150.

1-11. (canceled)

12. A method for determining a temperature of a sensor for detecting at least one property of a measured gas in a measured-gas space, the method comprising:
a) establishing an operating state by applying a heating voltage to at least one sensor element and establishing and detecting a substantially constant voltage state at the sensor element, wherein the sensor includes the at least one sensor element for detecting the property of the measured gas, the sensor element including at least one first electrode, at least one second electrode, and at least one solid electrolyte connecting the first electrode and the second electrode, and at least one electronic control unit;
b) carrying out at least one diagnosis sequence by establishing at least one first diagnosis state by impinging upon the sensor element with a diagnosis current, at least one second diagnosis state being established in which the diagnosis current is switched off, in the first diagnosis state detecting at least one first voltage value, and in the second diagnosis state detecting at least one second voltage value; and
c) determining an information item regarding the temperature from the first voltage value and the second voltage value, and from the constant voltage state of the operating state.

13. The method of claim 12, wherein a plurality of diagnosis sequences are carried out.

14. The method of claim 12, wherein in c) an internal resistance Rᵢₙₜ of the sensor element is determined from the relationship:
Rᵢₙₜ[t]=(U[i]+U[i−1]−2U_{offset})/I,
where i is an iteration step, U[i] is a measured voltage value of the i-th iteration step, U[i−1] is a measured voltage value of the (i−1)-th iteration step, the sensor element is impinged upon with a diagnosis current I, and U_{offset} is a voltage offset in the operating state.

15. The method of claim 12, wherein the first measured voltage value is determined during a settling process, and the second measured voltage value is determined during a decay process.

16. The method of claim 12, wherein a duration of the first diagnosis state and a duration of the second diagnosis state have an identical length.

17. The method of claim 12, wherein a capacity difference C_{diff} of at least one differential capacitance of the electronic control unit furthermore is determined from the relationship
$${C}_{diff} [ i ] = τ [ i ] / {R}_{int} [ i ] , \\ where$$
$$τ ( i ) = - \frac{{t}_{meas}}{log ( 1 - \frac{( U [ i ] - {U}_{offset} )}{{R}_{int} [ i ]} \cdot I )}$$
where τ is a time constant of the charging time of the effective differential total capacitance, i is an iteration step, U[i] is a measured voltage value of the i-th iteration step, U_{offset} is the offset voltage value, tₘₑₐₛ is a point in time of the measurement after energization is switched on or shut off, the sensor element is impinged upon with a diagnosis current I, and Rᵢₙₜ is the internal resistance.

18. A non-transitory computer readable medium having a computer program, which is executable by a processor, comprising:
a program code arrangement having program code for determining a temperature of a sensor for detecting at least one property of a measured gas in a measured-gas space, by performing the following:
a) establishing an operating state by applying a heating voltage to at least one sensor element and establishing and detecting a substantially constant voltage state at the sensor element, wherein the sensor includes the at least one sensor element for detecting the property of the measured gas, the sensor element including at least one first electrode, at least one second electrode, and at least one solid electrolyte connecting the first electrode and the second electrode, and at least one electronic control unit;
b) carrying out at least one diagnosis sequence by establishing at least one first diagnosis state by impinging upon the sensor element with a diagnosis current, at least one second diagnosis state being established in which the diagnosis current is switched off, in the first diagnosis state detecting at least one first voltage value, and in the second diagnosis state detecting at least one second voltage value; and
c) determining an information item regarding the temperature from the first voltage value and the second voltage value, and from the constant voltage state of the operating state.

19. The computer readable medium of claim 18, wherein in c) an internal resistance Rᵢₙₜ of the sensor element is determined from the relationship:
Rᵢₙₜ[i]=(U[t]+U[i−1]−2U_{offset})/I,
where i is an iteration step, U[i] is a measured voltage value of the i-th iteration step, U[i−1] is a measured voltage value of the (i−1)-th iteration step, the sensor element is impinged upon with a diagnosis current I, and U_{offset} is a voltage offset in the operating state.

20. An electronic control unit, comprising:
a non-transitory computer readable medium having a computer program, which is executable by a processor, including a program code arrangement having program code for determining a temperature of a sensor for detecting at least one property of a measured gas in a measured-gas space, by performing the following:
a) establishing an operating state by applying a heating voltage to at least one sensor element and establishing and detecting a substantially constant voltage state at the sensor element, wherein the sensor includes the at least one sensor element for detecting the property of the measured gas, the sensor element including at least one first electrode, at least one second electrode, and at least one solid electrolyte connecting the first electrode and the second electrode, and at least one electronic control unit;
b) carrying out at least one diagnosis sequence by establishing at least one first diagnosis state by impinging upon the sensor element with a diagnosis current, at least one second diagnosis state being established in which the diagnosis current is switched off, in the first diagnosis state detecting at least one first voltage value, and in the second diagnosis state detecting at least one second voltage value; and
c) determining an information item regarding the temperature from the first voltage value and the second voltage value, and from the constant voltage state of the operating state.

21. A sensor for detecting at least one property of a measured gas in a measured-gas space, comprising:
at least one sensor element for detecting the property of the measured gas, the sensor element having at least one first electrode, at least one second electrode, and at least one solid electrolyte connecting the first electrode and the second electrode; and
an electronic control unit, including a non-transitory computer readable medium having a computer program, which is executable by a processor, including a program code arrangement having program code for determining a temperature of a sensor for detecting at least one property of a measured gas in a measured-gas space, by performing the following:
a) establishing an operating state by applying a heating voltage to at least one sensor element and establishing and detecting a substantially constant voltage state at the sensor element, wherein the sensor includes the at least one sensor element for detecting the property of the measured gas, the sensor element including at least one first electrode, at least one second electrode, and at least one solid electrolyte connecting the first electrode and the second electrode, and at least one electronic control unit;
b) carrying out at least one diagnosis sequence by establishing at least one first diagnosis state by impinging upon the sensor element with a diagnosis current, at least one second diagnosis state being established in which the diagnosis current is switched off, in the first diagnosis state detecting at least one first voltage value, and in the second diagnosis state detecting at least one second voltage value; and
c) determining an information item regarding the temperature from the first voltage value and the second voltage value, and from the constant voltage state of the operating state.

22. The sensor of claim 21, further comprising:
at least one current source that is configured to impinge upon the sensor element with a current.
